(19) United States
(12) Patent Application Publication
(10) Pub. No.: US 2005/0242933 A1
(43) Pub. Date: Nov. 3, 2005

(54) Sensor assembly

(76) Inventor: Ko-Chin Loh, Johannesburg (ZA)

Correspondence Address: BIRCH STEWART KOLASCH & BIRCH, PO BOX 747, FALLS CHURCH, VA, 22040-0747, US

(21) Appl. No.: 11/050,765

(22) Filed: Feb. 7, 2005

(30) Foreign Application Priority Data
Apr. 28, 2004 (TW) 093206575
Apr. 28, 2004 (TW) 093206576
Apr. 28, 2004 (TW) 093206577
Apr. 28, 2004 (TW) 093206578

(51) Int. Cl. B60Q 1/00

(52) U.S. Cl. 340/435; 340/932.2; 340/693.9

(57) ABSTRACT

A sensor assembly disposed on a bumper of a vehicle is provided, and the bumper includes a containing space. The sensor assembly includes a sleeve structure and a sensor body assembly, wherein the sleeve structure is inserted in the containing space, and the sensor body assembly is connected with the sleeve structure for being accommodated in the sleeve structure.

### FIELD OF THE INVENTION

The present invention is related to a sensor assembly, and more particularly to a sensor assembly consisting of a sensor body assembly and a sleeve structure used in a bumper of a vehicle as a parking sensor.

### BACKGROUND OF THE INVENTION

In the populous city, it is quite troublesome for drivers to park, especially to park within a narrow street. When the vehicle is removing in the narrow street, such as reversing or parking, it would be difficult to avoid a small collision or rub between vehicles. Therefore, a parking sensor of the vehicle is generated accordingly.

Presently, a conventional parking sensor is mounted in a bumper of the vehicle, and the bumper therefore includes a predetermined assembled hole for inserting the parking sensor therein. However, different bumpers in different vehicles usually include different slopes for decreasing wind drag and enhancing appearance thereof. Please referring to FIG. 1, which is a conventional parking sensor embedded in a bumper of a vehicle. The parking sensor 11 includes a sensor body 12 and a sensor cable 13. The bumper 10 includes a specific slope and the conventional parking sensor 11 would not be corresponding to the specific slope of the bumper 10, so that the conventional parking sensor 11 includes a protrusion projected from the bumper 10, as shown in FIG. 1. Further, the protrusion is easy to be damaged by collision and be contaminated to affect the efficiency of the parking sensor 11. Therefore, the parking sensor 11 must be designed to different types in accordance with different slopes of the bumper 10, but the stock pressure for the manufacturer /distributor/retailer would be generated accordingly and it would not be provided with any economic benefits.

Moreover, the conventional procedure for assembling the parking sensor 11 usually includes the steps of disassembling the bumper 10 from the vehicle body, connecting the sensor cable 13 of the parking sensor 11 to the vehicle body, configuring the parking sensor 11 in the bumper 10, and reassembling the bumper 10 with the vehicle body. While the parking sensor 11 would be changed or repaired, the bumper 10 must be disassembled from the vehicle body and the changed or repaired parking sensor 11 must be reassembled by following the above process. Nevertheless, the procedure is quite inconvenient and is time consuming.

Therefore, a purpose of the present invention is to develop a structure to deal with the above situations encountered in the prior art.

### SUMMARY OF THE INVENTION

It is therefore an object of the present invention to provide a sensor assembly including a new assembling structure having different panel slopes for being corresponding to different slopes of different bumpers without increasing more manufacturing cost and stocks of expensive sensing components.

It is therefore another object of the present invention to provide a sensor assembly simplifying disassembling and reassembling process for the parking sensor, in which the sensor assembly includes a sleeve structure and a sensor body assembly, and the sleeve structure could be deposited in the bumper in advance for inserting the sensor body assembly easily.

It is therefore another object of the present invention to provide a sensor body assembly includes a shell structure for accommodating the sensor body composed of an ultrasonic sensing component, a PCB and a connector so as to avoid shock and damage, in which the shell structure includes two chambers for respectively accommodating the ultrasonic sensing component and the components, which at least including the PCB, on a back cover; a back cover with a connector socket for mounting and dismounting the sensor cable from bumper's front end without disassembling the bumper.

According to an aspect of the present invention, a sensor assembly disposed on a bumper of a vehicle is provided, and the bumper includes a hole. The sensor assembly includes a sleeve structure inserted in the hole, and a sensor body assembly connected with the sleeve structure for being accommodated in the sleeve structure.

Preferably, the sleeve structure is a fork-shaped cannular sleeve formed by an inclined panel and a plurality of planks parallel or symmetrical to others.

Preferably, the inclined panel includes a slope corresponding to that of the bumper.

Preferably, the slope is in the range the range between 0 degree and 36 degree.

Preferably, outer surfaces of the plank further include at least one pawl provided for fastening the sleeve structure to the bumper.

Preferably, the inner surfaces of the plank further include a first guide and a salient element, in which the first guide is provided for guiding the sensor body assembly to the sleeve structure, and the salient element is provided for fixing the sensor body assembly.

Preferably, outer surfaces of the sensor body assembly further include a second guide and a indentation, in which the second guide is corresponding to the first guide and used for engaging with the first guide, and the indentation is used for fastening the salient element

Preferably, the sensor body assembly includes a sensor body and a shell structure and the shell structure is provided for accommodating the sensor body.

Preferably, the sensor body includes an ultrasonic sensing component, a PCB and a connector.

Preferably, the shell structure further includes a back cover.

Preferably, the shell structure includes a front chamber and a back chamber, in which the front chamber is provided for mounting the ultrasonic sensing component and the back chamber is provided for accommodating the components, which a least including the PCB, on a back cover; the front chamber has a hollow baffle and the back chamber is next to the front chamber.

Preferably, the front chamber provides an inner rubber cushion with the shape corresponding to the front chamber and the inner rubber cushion is used for mounting the ultrasonic sensing component for absorbing vibration of the ultrasonic sensing component.

Preferably, a front end of the shell structure includes a plurality of hook-shaped flanges surrounding around the front end of the shell structure, and the flanges are provided with an outer rubber cushion covered therewith.

Preferably, the flanges are further connected to other flanges of another shell structure by staggeredly engaging with one another so as to remove the sensor body assembly from the sleeve structure.

Preferably, the flanges in the front end of the shell structure are configured to be equidistant.

Preferably, a back end of the shell structure has at least one opening for fastening the back cover.

Preferably, the back cover configures a connector socket connected to the sensor cable from its control box in the vehicle, and the inside of the back cover further includes at least one hook corresponding to the at least one opening of the shell structure for providing a connection between the shell structure and the back cover.

Preferably, the connector socket is a rectangle having three spacers around the connector socket, and two parallel of the three spacers respectively includes a bracket for inserting and fastening the PCB.

According to another aspect of the present invention, a sleeve structure of a sensor assembly provided for mounting a sensor body assembly is provided. The sleeve structure includes an inclined panel and a sleeve body, in which a slope of inner surfaces of the inclined panel is corresponding to that of a bumper of a vehicle and the sleeve body is laterally connected to the inner surfaces of the inclined panel to generate a cannular space for mounting the sensor body assembly.

According to another aspect of the present invention, a shell structure of a sensor body assembly provided for mounting a sensor body is provided, and the sensor body includes an ultrasonic sensing component, a PCB and a connector. The shell structure further includes a back cover, in which the shell structure includes a front chamber and a back chamber and the back cover is arranged on a back end of the shell structure. The front chamber has a hollow baffle for mounting the ultrasonic sensing component and the back chamber is next to the front chamber for accommodating the components, which at least including the PCB, on the back cover. In addition, the back end of the shell structure has at least one opening and the back cover includes at least one hook corresponding to the at least one opening so as to fasten the shell structure and a connector socket connected to the sensor cable which connects to the control box in the vehicle.

The above contents and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 is a schematic view showing a conventional parking sensor;

FIG. 2 is a schematic view showing a sensor assembly according to a preferred embodiment of the present invention;

FIG. 3 is a schematic view showing the elements of the sensor assembly shown in FIG. 2;

FIGS. 4(a) and 4(b) are schematic views respectively showing surface arrangements of a sleeve structure and a sensor body assembly according to the preferred embodiment of the present invention;

FIG. 5 is a cross-section view showing the sensor assembly deposited on a bumper of a vehicle;

FIGS. 6(a) and 6(b) are schematic views respectively showing a shell structure in different viewing directions according to the preferred embodiment of the present invention;

FIG. 7 is a cross-section view of the shell structure in FIG. 6;

FIGS. 8(a) and 8(b) are schematic views respectively showing an outer rubber cushion and an inner rubber cushion according to the preferred embodiment of the present invention;

FIG. 9 is a cross-section view of the shell structure combined with the outer rubber cushion and the inner rubber cushion shown in FIGS. 8(a) and 8(b);

FIGS. 10(a) and 10(b) are schematic views respectively showing the steps of removing the sensor body assembly from the sleeve structure by using another shell structure according to the preferred embodiment of the present invention;

FIG. 11 is a schematic view showing a back cover according to the preferred embodiment of the present invention; and

FIG. 12 is a schematic view showing the back cover with a connector socket and a PCB bracket accommodating a female connector and a PCB.

### DETAILED DESCRIPTION OF THE PREFERRED EMBODIMENTS

The present invention will now be described more specifically with reference to the following embodiment. It is to be noted that the following descriptions of preferred embodiment of this invention are presented herein for purpose of illustration and description only; it is not intended to be exhaustive or to be limited to the precise form disclosed.

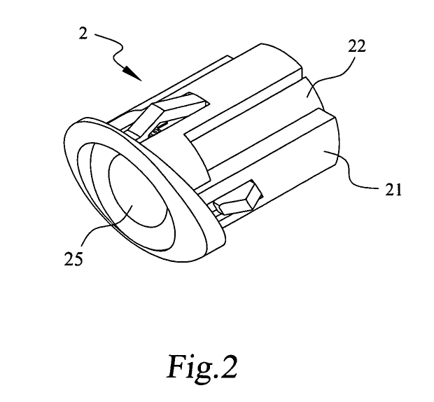

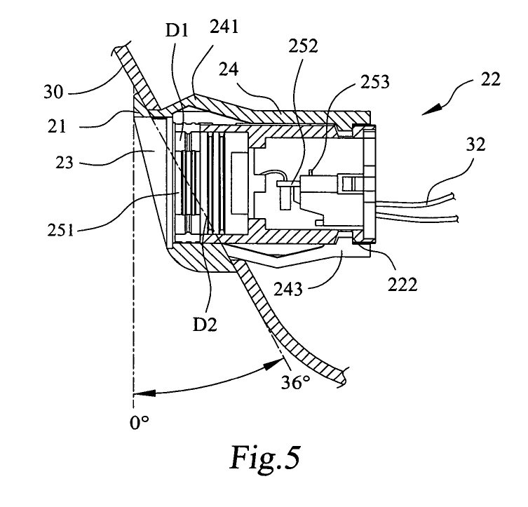

Referring to FIG. 2, which is a schematic view showing a sensor assembly according to a preferred embodiment of the present invention. The present sensor assembly 2 includes a sleeve structure 21 and a sensor body assembly 22, and the sensor body assembly 22 is provided for mounting a sensor body 25. Further, the sleeve structure 21 is deposited on a bumper 30 of a vehicle, as shown in FIG. 5. In addition, the sensor body 25 is a transducer which transmits and received ultrasonic waves to the vehicle. Furthermore, the sensor body assembly 22 is entirely sunk into the sleeve structure 21 with less protrusion than conventional parking sensor, so that the sensor assembly 2 could prevent the sensor body 25 of the sensor body assembly 22 from any external damages, such as car washing and rocks bouncing from ground.

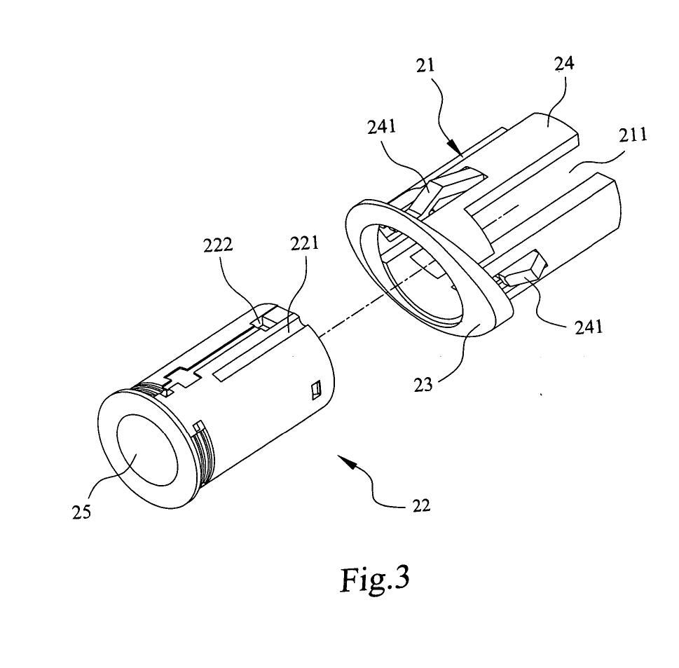

Please refer to FIG. 3, which is showing the elements of the sensor assembly of FIG. 2. The sleeve structure 21 is a fork-shaped cannular sleeve including a cannular space 211, and the cannular space 211 is provided for mounting the sensor body assembly 22. Moreover, the sleeve structure 21 includes an inclined panel 23 and a plurality of planks 24, and these planks 24 are respectively parallel or symmetrical to others. These planks 24 form a sleeve body including the cannular space 211 laterally connected to the inner surfaces of the inclined panel 23. Further, the inclined panel 23 includes a slope corresponding to that of the bumper 30 and the plank 24 includes a pawl 241 for fastening the sleeve structure 21 to the bumper 30, as shown in FIG. 5.

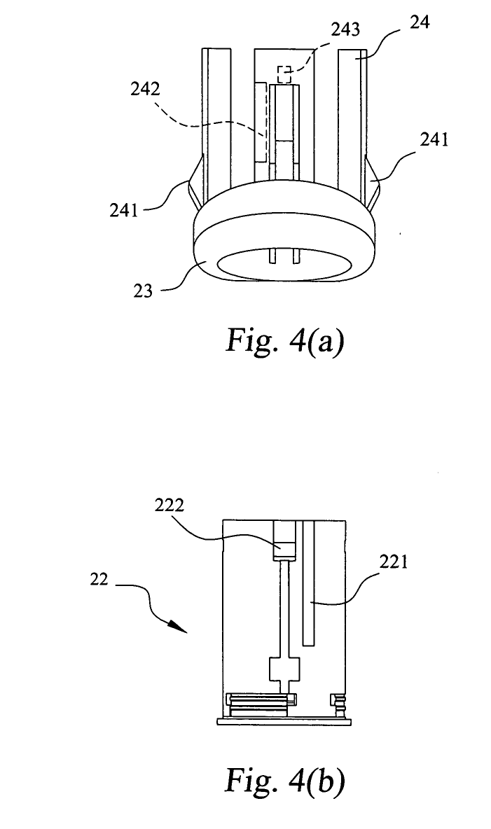

In FIGS. 4(a) and 4(b), are respectively showing surface arrangements of the sleeve structure 21 and the sensor body assembly 22. Please refer to FIG. 4(a). In outer surfaces of the plank 24, the plank 24 includes the pawl 241 for fastening the sleeve structure 21 to the bumper 30. Besides, the plank 24 further includes a first guide 242 and a salient element 243 in the inner surfaces of the plank 24. The first guide 242 is provided for guiding the sensor body assembly 22 to the sleeve structure 21, and the salient element 243 is provided for fixing the sensor body assembly 22. In FIG. 4(b), outer surfaces of the sensor body assembly 22 include a second guide 221 and a indentation 222. Further, the location of the second guide 221 is corresponding to that of the first guide 242, so that the second guide 221 is used for engaging with the first guide 242. In addition, the location of the indentation 222 is corresponding to that of the salient element 243, so that the indentation 222 is used for fastening the salient element 243 so as to fix the sleeve structure 21 and the sensor body assembly 22.

Please refer to FIG. 5, which is a cross-section view showing the sensor assembly deposited on the bumper of the vehicle. Because the bumper 30 usually includes various slopes, the inclined panel 23 is designed to include a slope matching with the slope of the bumper 30, and the slope is preferably in the range the range between 0 degree and 36 degree. Moreover, a theory of “half in and half out” is applied on the inclined panel 23 to reduce its protrusion as well as the mass. Further, the assembly between the bumper 30 and the sleeve structure 21 is performed by using the pawl 241 and the assembly between the sleeve structure 21 and the sensor body assembly 22 is performed by using the salient element 243 of the plank 24 and the indentation 222 of the sensor body assembly. In practice, a hole would be drilled on the bumper 30, and the sleeve structure 21 could be inserted into the hole and be fastened with the bumper 30 by the pawl 241.

In addition, the sensor body 25 shown in FIGS. 2 and 3 includes an ultrasonic sensing component 251, a PCB 252 and a connector 253, in which the ultrasonic sensing component 251 of FIG. 5 is hidden within outer rubber cushion D1 and an inner rubber cushion D2. The ultrasonic sensing component 251 is provided for sensing ambient conditions in front of the bumper 30 by transmitting ultrasonic waves. The ultrasonic waves would be transmitted through the PCB 252 and the connector 253 to the control box.

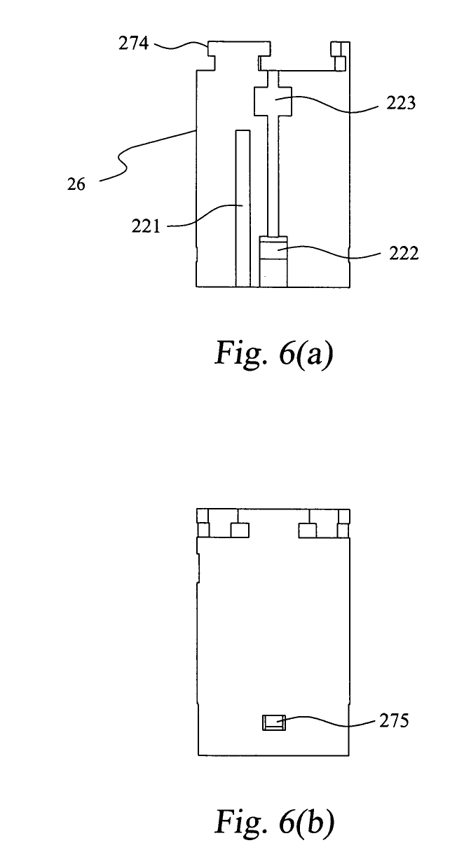

According to the above description, the sensor body assembly 22 includes the sensor body 25 in the interior thereof for providing main sensing function of the sensor assembly 2, so that the sensor body assembly 22 must include a shell structure 26 in the exterior thereof for accommodating the sensor body 25. Please refer to FIGS. 6(a) and 6(b), which are respectively showing the shell structure in different viewing directions. The shell structure 26 belongs a shell appearance of the sensor body assembly 22, so that the shell structure 26 includes the second guide 221, the indentation 222 and an alignment line 223 arranged in front of the indentation 222, as shown in FIG. 6(a). And, a plurality of hook-shaped flanges 274 is arranged around the front end of the shell structure 26. In another view of FIG. 6(b), the shell structure 26 further includes at least one opening 275 in a back end thereof.

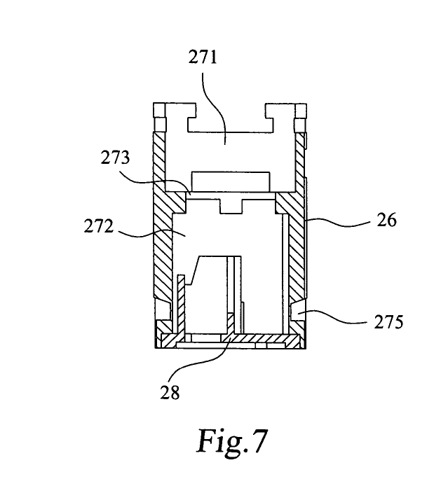

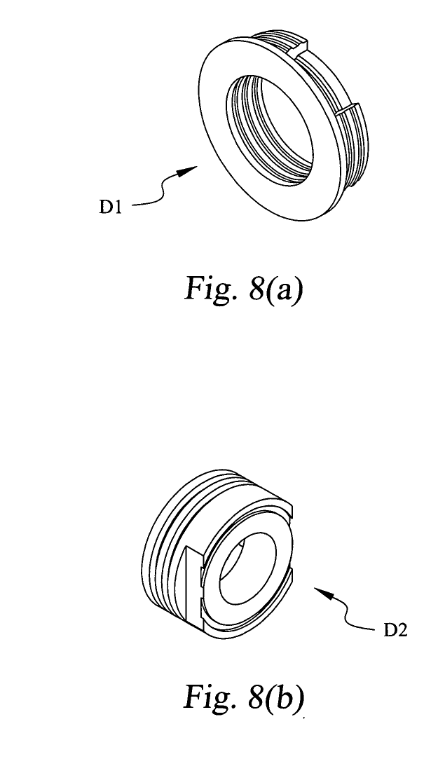

In FIG. 7, which is a cross-section view of the shell structure of FIG. 6. The shell structure 26 is formed by a back cover 28. The shell structure 26 includes a front chamber 271 and a back chamber 272, and the back chamber 272 is next to the front chamber 271. Moreover, the front chamber 271 is provided for mounting the ultrasonic sensing component 251 and the back chamber 272 is provided for accommodating components mounted on the back cover, as shown in FIG. 5. Further, the front chamber 271 has a hollow baffle 273, and the front chamber 271 provides the inner rubber cushion D2 mounted on the top on the hollow baffle 273 and the shape of the inner rubber cushion D2 is matching with the shapes of the hollow baffle 273 within and the ultrasonic sensing component 251 without in the front chamber 271. Besides, the hook-shaped flange 274 arranged on the front end of the shell structure 26, includes the outer rubber cushion D1 covered therewith. The hook-shaped flanges 274 can be configured to be equidistant arrangement or otherwise. The concrete appearances of the outer rubber cushion D1 and the inner rubber cushion D2 are respectively shown in FIGS. 8(a) and 8(b). The inner rubber cushion D2 is deposited on the top of the hollow baffle 273 and the ultrasonic sensing component 251 is mounted on the inner rubber cushion D2. And, the inner rubber cushion D2 is made of rubber, silicone or other buffer materials for providing a better vibration absorbing or shock protection, so that the ultrasonic sensing component 251 could be not easy to be damaged or generated false alarm and still maintain the better sensing sensitivity. The outer rubber cushion D1 is arranged on the hook-shaped flanges 274 and also can cover the ultrasonic sensing component 251 therewith. Refer to FIGS. 8(a) and 8(b), the outer rubber cushion D1 and the inner rubber cushion D2 respectively include a hole for mounting the ultrasonic sensing component 251 therein. Therefore, the outer rubber cushion D1 could be similarly made of rubber, silicone or other buffer materials, so that the outer rubber cushion D1 also provide a better vibration absorbing or shock protection for the ultrasonic sensing component 251.

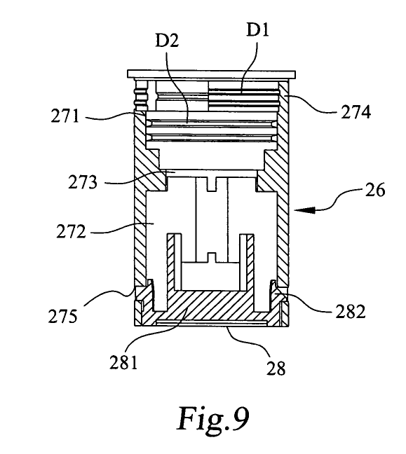

Please refer to FIG. 9, which is cross-section view of the shell structure combined with the outer rubber cushion and the inner rubber cushion in FIGS. 8(a) and 8(b). In FIG. 9, the front chamber 271 includes the outer rubber cushion D1 and the inner rubber cushion D2 for sealing up the ultrasonic sensing component 251. Further, the shell structure 26 includes the back cover 28 according to the above description. In FIG. 6(b) and FIG. 7, the shell structure, includes the opening 275 in the back end thereof. In FIG. 9, the back cover 28 further includes a hook 282 in the inside thereof. And, the location of the opening 275 is corresponding to that of the hook 282 so as to fasten the shell structure 26 and the back cover 28.

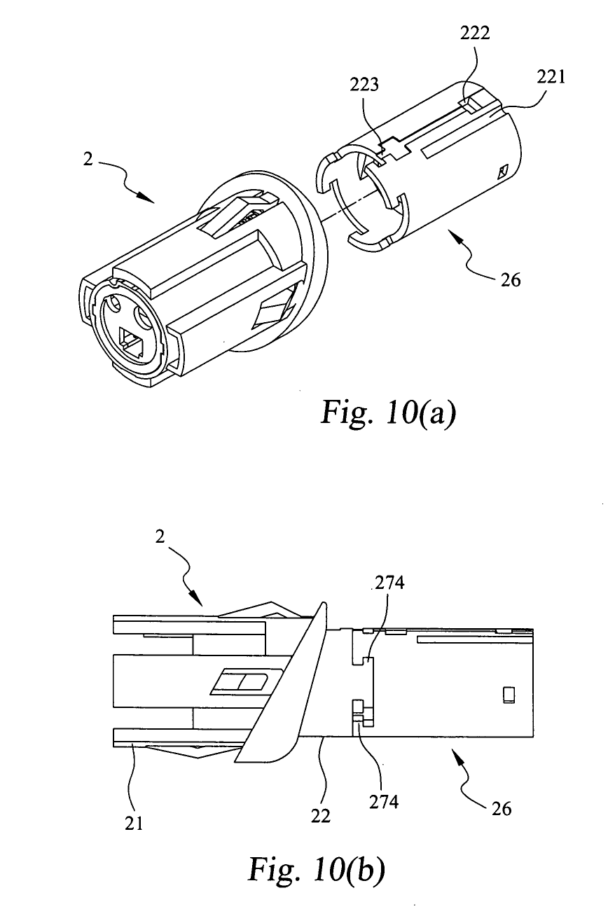

According to the above description, the present invention provides a combined parking sensor structure, i.e. the present sensor assembly 2, for isolating the manufacturing process of the sensor body assembly 22 and the sleeve structure 21 to decrease the stock and labor cost of the sensor body assembly 22. Furthermore, the present invention further provides a convenient method for disengaging or engaging the sensor assembly 2. Please refer to FIGS. 10(a) and 10(b), which is showing the steps of removing the sensor body assembly from the sleeve structure by using an extra shell structure. First, the outer rubber cushion D1 of the sensor assembly 2 should be taken out, and the sensor assembly 2 would be connected to an extra shell structure 26 without the outer rubber cushion D1. Further, other hook-shaped flanges 274 of the extra shell structure 26 would be pushed in staggered spaces of the hook-shaped flanges 274 of the sensor assembly 2, and then the extra shell structure 26 would be turned for lock-in engagement, as shown in FIG. 10(b). Finally, the sensor body assembly 22 and the extra shell structure 26 would be engaged with each other, and the sensor body assembly 22 of the sensor assembly 2 would be pulled out easily. In general, the engagement between the sensor body assembly 22 and the extra shell structure 26 could be easily accomplished according to directly corresponding with the alignment lines 223 respectively arranged on sensor body assembly 22 and the shell structure 26.

Furthermore, the sensor body assembly 22 inserted into the sleeve structure 21 is the reverse process of its removal. The outer rubber cushion D1 in the sensor body assembly 22 would be taken out. The sensor body assembly 22 could be engaged by using the extra shell structure 26 or directly pushed into the sleeve structure 21 without touching the sensor body 25 in the sensor body assembly 22. Further, the outer rubber cushion D1 would be covered with the sensor body assembly 22.

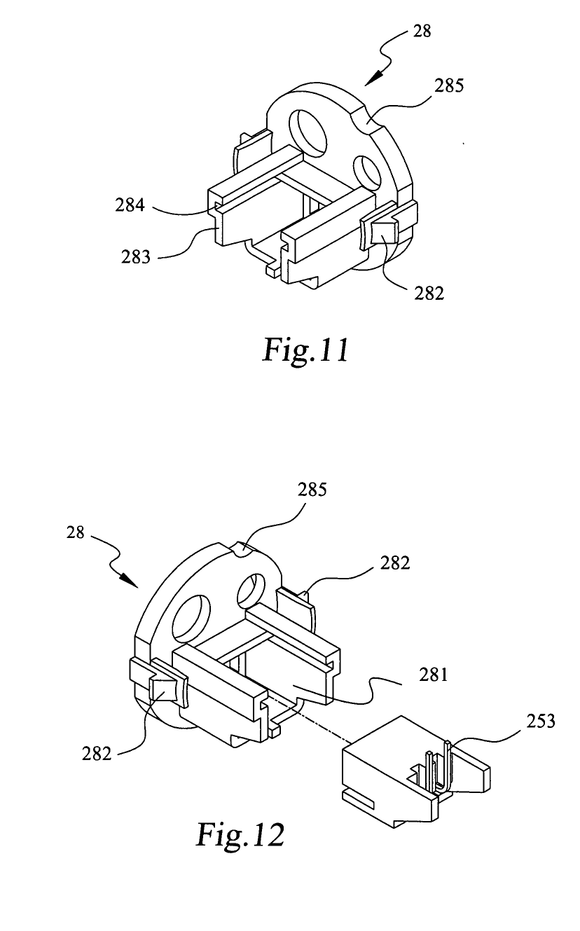

Please refer to FIGS. 11 and 12, which is showing the back cover structure. According to the description of FIG. 9, the back cover 28 is fastened with the shell structure 26 and the back cover 28 includes two hook 282 in the inside of the back cover 28 for fastening the corresponding opening 275 of the shell structure. Moreover, the back cover 28 includes a recess 285 arranged on outer edge of the back cover 28, and the location of the recess 285 is corresponding to that of the second guide 221 for enhancing the engagement between the shell structure 26 and the back cover 28, as shown in FIG. 3 or FIG. 10(a). The back cover 28 further includes a rectangle connector socket 281. The connector socket 281 would accommodate a female connector, which connects PCB within and sensor cable without. The connector socket 281 which connects PCD within, the connector socket 281 is connected to the connector 253, and also includes three spacers 283 therearound, in which two parallel of the three spacers 283 respectively includes a bracket 284 for inserting and fastening the PCB 252, as shown in FIG. 5. Furthermore, the connector socket 281which connects sensor cable without, the connector socket 281 is provided for mounting the conducting plug 32 of the sensor cable. Therefore, the PCB 252 and the connector 253 are respectively configured to be the upper and the lower location of the connector socket 281 and the ultrasonic sensing component 251 is surrounded between the outer rubber cushion D1 and the inner rubber cushion D2, so that the sensing function of the sensor assembly 2 would be not affected by any shocks or vibrations from driving or collision.

Therefore, according to the above description, it is understood that the concrete structure for the present sensor assembly can overcome the defects generated from the prior parking sensor. Further, the differences between the prior art and the present invention and the advancements of the present invention, are described as follow.

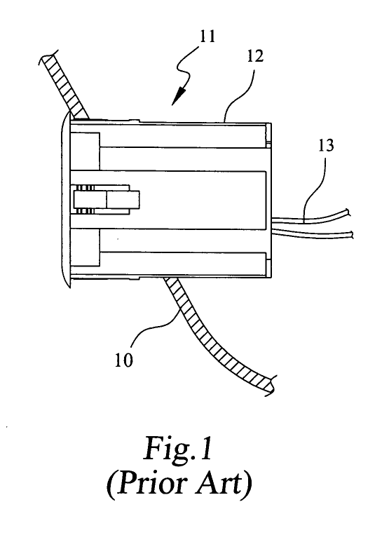

Compared with the conventional parking sensor according to FIG. 1, the parking sensor 11 is integrally formed, and the casing and the sensing device of the sensor body 12 would be not permitted to detach. The sensing device is used for providing the main sensing function of the parking sensor 11, and labor cost of the sensing devices is higher than present sensor assembly 2. Moreover, the shapes of the parking sensor 11 must be matched with the shapes of the bumper 10, so that the parking sensors 11 with various shapes must be produced corresponding to the bumpers 10 and both labor cost and dead stock are increased accordingly. However, the present sensor assembly 2 is combined with the sleeve structure 21 and the sensor body assembly 22. The shape of the sensor body assembly 22 is a fixed shape and the shapes of the sleeve structure 21 would be easily changed according to the shapes of the bumpers. The sleeve structure 21 merely is made of plastics and is aiming at the goal of cost down.

In addition, the assembling or disassembling process for the present sensor assembly 2 is quite simple. The present sensor assembly 2 includes the connector socket 281 deposited on the back cover 28 for mounting the conducting plug 32 of sensor cable, so that the sensor cable would be connected to the connector socket 281 and then the sensor assembly 2 could be directly inserted into to the bumper 30 without taking out the bumper 30. Furthermore, connection between the sleeve structure 21 and the sensor body assembly 22 could be easily disengaged or engaged by using the extra shell structure 26.

In conclusion, it is understood that the present sensor assembly with its “half in and half out” design should decrease in the proportion of protrusion and have a good-looking appearance than conventional parking sensor. Furthermore, the present sensor assembly can be engaged and disengaged easily and efficiently from the bumper. From manufacturing the different sleeve structure to accommodate one sensor body assembly would reduce the dead stock and save more labor cost. Further, excellent anti-shock and vibration absorbing for the sensor body are achieved by providing multiple effective fastening or protecting structure according to the present invention.

While the invention has been described in terms of what are presently considered to be the most practical and preferred embodiments, it is to be understood that the invention need not to be limited to the disclosed embodiment. On the contrary, it is intended to cover various modifications and similar arrangements included within the spirit and scope of the appended claims which are to be accorded with the broadest interpretation so as to encompass all such modifications and similar structures.

1. A sensor assembly disposed on a bumper of a vehicle, wherein said bumper includes a hole, said sensor assembly comprising:
a sleeve structure inserted in said hole; and
a sensor body assembly connected with said sleeve structure and provided for being accommodated in said sleeve structure.

2. The sensor assembly according to claim 1, wherein said sleeve structure is a fork-shaped cannular sleeve formed by an inclined panel and a plurality of planks parallel or symmetrical to others.

3. The sensor assembly according to claim 2, wherein said inclined panel includes a slope is corresponding to that of the bumper.

4. The sensor assembly according to claim 3, wherein said slope is preferably in the range the range between 0 degree and 36 degree.

5. The sensor assembly according to claim 2, wherein outer surfaces of said plank further include at least one pawl and are used for fastening said sleeve structure to said bumper.

6. The sensor assembly according to claim 2, wherein inner surfaces of said plank further include:
a first guide provided for guiding said sensor body assembly to said sleeve structure; and
a salient element provided for fixing said sensor body assembly.

7. The sensor assembly according to claim 6, wherein outer surfaces of said sensor body assembly further include:
a second guide corresponding to said first guide and provided for engaging with said first guide; and
a indentation provided for fastening said salient element.

8. The sensor assembly according to claim 1, wherein said sensor body assembly includes a sensor body and a shell structure used for accommodating said sensor body.

9. The sensor assembly according to claim 8, wherein said sensor body includes an ultrasonic sensing component, a PCB and a connector.

10. The sensor assembly according to claim 9, wherein said shell structure further includes a back cover.

11. The sensor assembly according to claim 10, wherein said shell structure includes a front chamber used for mounting said ultrasonic sensing component and a back chamber used for accommodating the components, which at least including the PCB, on a back cover; said front chamber has a hollow baffle and said back chamber is next to said front chamber.

12. The sensor assembly according to claim 11, wherein said front chamber provides an inner rubber cushion with the shape corresponding to said front chamber and said inner rubber cushion is provided for mounting said ultrasonic sensing component to absorb vibration of said ultrasonic sensing component.

13. The sensor assembly according to claim 12, wherein a front end of said shell structure includes a plurality of hook-shaped flanges surrounding therearound, and said flanges are provided with an outer rubber cushion covered therewith.

14. The sensor assembly according to claim 13, wherein said flanges are further connected to other flanges of another shell structure by staggeredly engaging with one another so as to remove said sensor body assembly from said sleeve structure.

15. The sensor assembly according to claim 13, wherein said flanges in said front end of said shell structure are configured to be equidistant.

16. The sensor assembly according to claim 10, wherein a back end of said shell structure has at least one opening for fastening said back cover.

17. The sensor assembly according to claim 16, wherein said back cover configures a connector socket connected to the sensor cable from its control box in the vehicle, and the inside of said back cover further includes at least one hook corresponding to said at least one opening of said shell structure for providing a connection between said shell structure and said back cover.

18. The sensor assembly according to claim 17, wherein said connector socket is a rectangle having three spacers around said connector socket, and two parallel of said three spacers respectively includes a bracket for inserting and fastening said PCB.

19. A sleeve structure of a sensor assembly for mounting a sensor body assembly, said sleeve structure comprising:
an inclined panel, wherein a slope of inner surfaces thereof is corresponding to that of a bumper of a vehicle; and
a sleeve body laterally connected to said inner surfaces of said inclined panel to generate a cannular space for mounting said sensor body assembly.

20. A shell structure of a sensor body assembly for mounting a sensor body, wherein said sensor body includes an ultrasonic sensing component, a PCB and a connector, said shell structure comprising:
a shell structure including a front chamber having a hollow baffle for mounting said ultrasonic sensing component and a back chamber next to said front chamber for accommodating the components, which at least including the PCB, on the back cover, wherein a back end of said shell structure has at least one opening; and
a back cover arranged on said back end of said shell structure, including at least one hook corresponding to said at least one opening for fastening said shell structure and a connector socket connected to the sensor cable which connects to the control box in the vehicle.
